(19) United States
(12) Patent Application Publication
(10) Pub. No.: US 2017/0304930 A1
(43) Pub. Date: Oct. 26, 2017

(54) COIL FOR THE MAGNETIC-PULSE WELDING OF TUBULAR PARTS AND RELATED WELDING METHOD

(71) Applicant: ADM28 S.ÀR.L, LUXEMBOURG (LU)

(72) Inventors: GILLES AVRILLAUD, PINSAGUEL (FR); JEAN-PAUL CUQ LELANDAIS, CUGNAUX (FR); SAMUEL FERREIRA, TOULOUSE (FR)

(21) Appl. No.: 15/512,831

(22) PCT Filed: Sep. 23, 2015
(86) PCT No.: PCT/EP2015/071825

§ 371 Date: Mar. 20, 2017

(30) Foreign Application Priority Data
Sep. 23, 2014 (FR) 1458947

(51) Int. Cl. B23K 20/06; B23K 101/06

(52) U.S. Cl. CPC B23K 20/06; B23K 2201/06

(57) ABSTRACT

A coil to magnetic-pulse weld tubular parts including an active portion having an active surface which is arrangeable to face an area of overlap between the tubular parts. The active surface defines a tubular opening oriented in an axial direction. The active surface has a predetermined axial length. The tubular opening has, in the axial direction, along the axial length of the peripheral surface, two sections having a constant cross-section. The two sections are connected therebetween by a section having a continuously increasing cross-section. A related magnetic-pulse welding method is also provided herewith.

### FIELD OF THE INVENTION

The present invention relates to the field of welding, and more particularly the field of magnetic-pulse welding, for assembling parts together permanently. The present invention relates in particular to an enhanced coil embodiment for the welding of tubular parts.

### STATE OF THE ART

Magnetic-pulse welding belongs to the field of impact welding methods making it possible to produce a bond between two metal parts by pressure against one another in an overlap zone. The principle of such a magnetic-pulse welding method is based primarily on the high-velocity impact of the parts by virtue of the electromagnetic forces generated by a coil.

Conventionally, a system for implementing such a magnetic-pulse welding method comprises one or more capacitors linked to a coil to create a brief and intense magnetic field. The capacitor or capacitors is/are used to store a large quantity of electrical energy. The intense magnetic field created is the result of a very rapid discharge of this electrical energy into the coil.

In order to achieve the welding of two parts together with such a method, said two parts are previously superposed on one another, at least over a so-called overlap zone. The coil is positioned at the level of this overlap zone. The part called outer part is that which is positioned close to the coil, without being in contact therewith, and the part called inner part is that which is furthest away from the coil. A very large quantity of electrical energy, previously stored in the capacitor or capacitors, is suddenly discharged into the coil, in the form of a variable current of very high intensity, in a very short time. By way of example, some systems can achieve several hundreds of thousands of amperes in a few microseconds. The current generates a variable magnetic field between the coil and the outer part and induces eddy currents in this outer part. These eddy currents associated with the surrounding magnetic field develop, in the outer part, significant volume forces called Lorentz forces. These forces generate a strong acceleration of the outer part toward the inner part. The collision speed of the outer part on the inner part can rise to several hundreds of m/s. When certain impact conditions, notably the collision angle and the collision speed are met, this impact generates, on the one hand, a jet of material which will clean the surface of the two parts, and, on the other hand, a pressure which will bring the atoms of the materials of the two parts against one another such that their natural repelling forces are overcome, thus resulting in a fusion-free metal bond. The wall of the outer part is then not only linked from a metallurgical point of view to the wall of the inner part but has also undergone a remnant deformation.

Such a magnetic-pulse welding method is commonly used for assembling tubular parts, via a so-called annular coil.

One advantage of such a magnetic-pulse welding method lies in the fact that the assembly of the two parts is performed in the solid state, which makes it possible to address all the known problems in conventional welding involving the melting of the materials. The energy losses are thus minimal and consequently the parts to be welded do not heat up a lot. The absence of melting in the parts during the welding thus makes it possible to assemble materials that have different melting points.

The magnetic-pulse welding method does however present the drawback of requiring strong intensities to weld the parts together. The use of such intensities generates, in the coil, significant temperatures and stresses, that can lead to irreversible damage to the coil, such as cracks or melting of the coil.

Another drawback with this method lies also in the quality of the weld produced. A contact between the two parts is not a guarantee of welding.

For the welding to take place, several parameters have to be taken into account, in particular the collision angle and the collision speed. These two parameters are linked to the initial relative arrangement of the coil and of the two parts to be welded, to the materials of the parts and to the current signal used.

To recap, the collision speed is the radial collision speed between the two parts. The collision point speed, which is tangential to the parts, is also defined. The collision speed and the collision point speed are linked by the collision angle. These collision and collision point speeds change upon the impact. The collision point speed can rise to several thousands of m/s.

The collision angle is defined as the angle between the walls of the two parts upon the collision. The collision angle is dynamic, that is to say that it changes during the collision, particularly because the outer part is deformed non-uniformly.

Each pair of materials is defined by a welding window, that is to say a set of parameters (collision angle, collision point speed), making it possible to produce a weld of good quality. Changing one of the parameters can have consequences on the quality of the weld. Among other things, with the collision angle changing during the collision, it is difficult to remain within the welding window.

### SUMMARY OF THE INVENTION

The aim of the present invention is to remedy these drawbacks.

The aim of the present invention is notably to provide an efficient solution that makes it possible to weld tubular parts, while ensuring the mechanical strength of the item obtained by such a weld and while guaranteeing a healthy weld.

The invention thus relates to a coil for the magnetic-pulse welding of tubular parts comprising an active portion of which a surface, called peripheral surface, is configured and intended to be positioned facing a mutual overlap zone of the tubular parts.

Tubular parts should be understood to be parts in the form of a tube over all or part of their length, at least at the level of the overlap zone.

An active portion should be understood to be a zone of the coil where a current is concentrated and circulates, delivered by an electrical energy storage unit, to create a magnetic field at the level of the coil aperture. A thickness of the active zone corresponds substantially to the skin thickness. At high frequency, the current circulates over a reduced thickness corresponding to the skin thickness. The frequency applied in the magnetic-pulse welding is a few tens of kHz, which corresponds for example to a skin thickness of a few millimeters for a coil produced in a steel material.

The peripheral surface preferentially defines a zone, where the welding of the tubular parts will be produced, in the form of a tubular aperture. The tubular parts are intended to be arranged relative to one another to form, at the level of their superposition, the overlap zone, then to be inserted into the tubular aperture of the coil, facing the peripheral surface of the coil, to be welded therein at the level of a working zone by the magnetic field generated by the coil.

The working zone is the portion of the overlap zone situated facing the active portion. Said working zone has a working length L_{wz} corresponding to a maximum welding length between the inner part and the outer part.

Said tubular aperture is elongate in an axial direction, substantially equivalent to an axial direction of the tubular parts when said tubular parts are arranged in the tubular aperture of the coil and immobilized in position by fixing means. The peripheral surface has, in the axial direction, a given axial length.

According to the invention, the tubular aperture has, in the axial direction, an increasing cross section over the axial length of the peripheral surface.

The axial length of the peripheral surface is dimensioned so as to allow the production of a weld of predefined length between said parts. This predefined length is the welding length. Preferably, the axial length of the peripheral surface is at least equal to the welding length.

Such a form of coil, through the change in cross section of the tubular aperture over the axial length of the peripheral surface of the coil, advantageously makes it possible to vary a gap between the coil and the part closest to the peripheral surface of the coil, called outer part, which modifies the fundamental parameters that are the collision point speed and the collision angle. Such a tubular aperture profile makes it possible, when the outer part is introduced such that its end is situated at the level of the smallest cross section of the tubular aperture, to retain a substantially constant collision angle, which makes it possible to remain longer within the welding window of the pair of materials of the tubular parts to be welded. The welding length between the two parts is increased, thus improving the mechanical strength of the assembly.

Another advantage of the coil according to the invention lies in the fact that the maximum stresses, in terms of temperature and of plastic deformation, undergone by the coil, and generated by the passage of the very high intensity current in the coil, are reduced. A change in the profile of the tubular aperture of the coil leads to a change in the distribution of current in the active zone. In effect, one of the parameters involved is the distance between the peripheral surface of the coil and the outer part. The current density in the active portion decreases with the increase in distance between the peripheral surface of the coil and the outer part. Since the current density is in fact inversely proportional to this distance, the profile of the tubular aperture of the coil according to the invention thus makes it possible to increase the distance with the zone of the coil where the current density was the highest. In this zone, the stresses are therefore reduced. The life of the coil is significantly increased.

According to preferred implementations, the invention also meets the following features, implemented separately or in each of their technically feasible combinations.

According to preferred embodiments, the tubular aperture has, in the axial direction, an increasing cross section over all of the axial length of the peripheral surface.

According to preferred embodiments, the tubular aperture has, over the axial length of the peripheral surface, two tubular sections of constant cross section linked together by a tubular section of monotonically increasing cross section.

According to preferred embodiments, to reduce the plastic deformations in the coil during the welding of the tubular parts, the active portion comprises, on either side of the peripheral surface defining the tubular aperture, a chamfered and/or shelved portion.

According to preferred embodiments, the coil comprises a magnetic field concentrator comprising the active portion. The magnetic field concentrator is positioned between the outer part and the peripheral surface of the coil. The active portion is then created in said magnetic field concentrator.

The magnetic field concentrator is advantageously an interchangeable part, and makes it possible to retain one and the same coil for several applications (change in diameter of the cylindrical parts, etc.).

The coil, according to at least one of its embodiments, forms, with the tubular parts, when the latter are in position at the level of the coil, a welding set. The two tubular parts are preferably arranged one inside the other coaxially and positioned in the tubular aperture such that all or part of the overlap zone is facing the active portion.

The invention also relates to a method for the magnetic-pulse welding of two tubular parts. The method comprises the steps of:
arranging the tubular parts relative to one another to form a working zone, facing the peripheral surface of a coil according to at least one of its embodiments, such that an end of one of the parts is positioned at the level of the smallest cross section of the tubular aperture,
subjecting the working zone to a magnetic field such that a pressure is exerted on a wall, called outer wall, of one of the tubular parts and pressing it closely against a wall, called outer wall, of the other tubular part to provoke the permanent bonding thereof; this step is called welding step.

The two tubular parts are positioned one inside the other to form the overlap zone. The two tubular parts are arranged in the coil such that the working zone situated in the overlap zone is placed in the tubular aperture of the coil, facing the peripheral surface.

In a preferred example of implementation, the part closest to the coil, that is to say the outer part, is positioned such that its end is placed at the level of the smallest cross section of the tubular aperture.

In a preferred form of implementation, when the tubular aperture has, over the axial length of the peripheral surface, two tubular sections of constant cross section linked together by a tubular section of monotonically increasing cross section, the part closest to the coil is positioned such that its end is placed at the level of the tubular section of smallest cross section.

In the welding step, the working zone is subjected to a magnetic field originating from the active portion of the coil such that a pressure is exerted on the outer wall of the tubular part closest to the coil, and presses it closely against the outer wall of the other tubular part to provoke the permanent bonding thereof.

Thus, when the working zone is subjected to the magnetic field generated by the coil ensuring the welding by pressure, the two tubular parts are pressed closely against one another by the speed imparted on and the deformation of the tubular part closest to the coil toward the other tubular part.

Such a method makes it possible to maintain, in the welding step, a collision angle between the two tubular parts that is substantially constant, which makes it possible to remain within the welding window of the pair of materials forming the tubular parts to be welded. Thus, the weld produced is improved and the welding length is increased.

Such a method also makes it possible to improve the withstand strength of the coil to the thermal stresses and plastic deformations in the welding step.

### DESCRIPTION OF THE FIGURES

The invention will be better understood on reading the following description given with reference to the attached drawings:

FIG. 1 schematically represents a perspective view of a coil for magnetic-pulse welding, according to an embodiment of the invention;

FIG. 2 schematically represents a front view of the coil of FIG. 1;

FIG. 3 represents a transverse cross section of the coil of FIG. 2 along the line AA, illustrating the profile of an active portion of said coil;

FIG. 4 represents an enlargement of a part of the profile of the active portion of the coil of FIG. 3;

FIG. 5 illustrates a comparison between the welding distances obtained by a coil of the prior art and a coil according to an embodiment of the invention, for a same pair of materials; and

FIGS. 6a and 6b illustrate a comparison between measurements of temperature generated in a coil of the prior art and in a coil according to an embodiment of the invention.

### DETAILED DESCRIPTION OF AN EMBODIMENT OF THE INVENTION

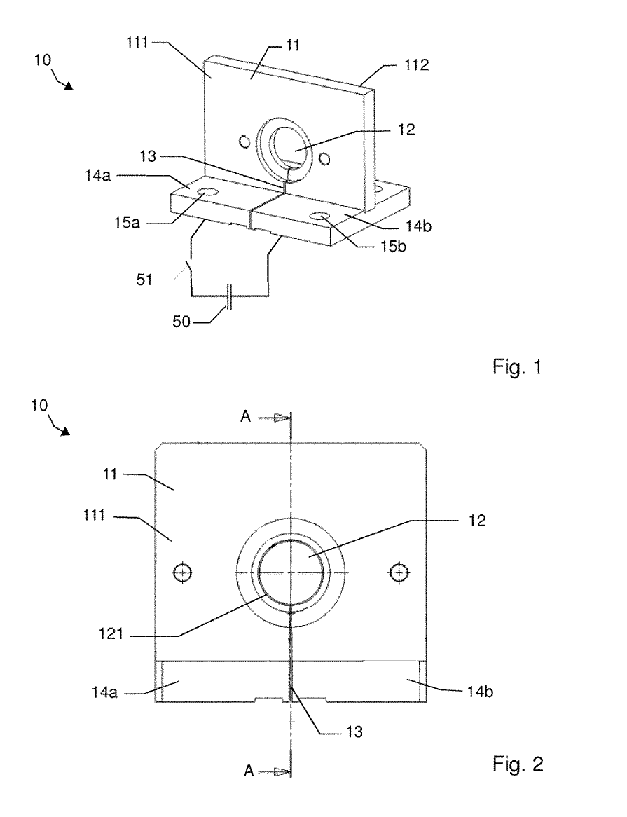

FIGS. 1 to 4 illustrate a coil 10 for the magnetic-pulse welding of the two tubular parts 20, 30, according to a first embodiment. The two parts 20, 30 are produced in a metal material.

Such a coil 10 forms an integral part of a magnetic-pulse welding device which further comprises a storage unit 50 and one or more switches 51.

The storage unit 50 is configured and intended to store up a high energy, for example of the order of a few tens of kilojoules (kJ).

In a preferred embodiment, the storage unit is a battery of discharge capacitors.

The coil, for its part, is configured and intended to create a magnetic field concentrated in a delimited space, described later.

A first cylindrical tubular part, called outer part 20, has a diameter substantially greater than a diameter of a second cylindrical tubular part, called inner part 30, such that the inner part 30 penetrates into the outer part 20, with play.

The two cylindrical tubular parts 20, 30 are intended to be arranged one inside the other, coaxially, to form, at the level of their superposition, a so-called overlap zone 25, then to be welded at the level of all or part of said overlap zone by the coil 10.

Preferably, the overlap zone 25 is situated at the level of an end of at least one part, for example an end of the outer part 20.

The coil and the two tubular parts form, when said two tubular parts are in position at the level of the coil, a welding set.

In an embodiment that is not represented, when the outer part 20 is produced in a material exhibiting a very low electrical conductivity, such as, for example, a part produced in steel, an intermediate part, called pusher, preferentially cylindrical tubular, is positioned against an outer wall of the outer part. This intermediate part exhibits a good electrical conductivity.

A material exhibiting a very low electrical conductivity should be understood to be a material whose electrical conductivity is less than 10 MS/m.

The coil 10, generally called annular coil, comprises a body 11 in which is formed a tubular aperture 12 delimited by a so-called peripheral surface 121. Said tubular aperture is designed to receive the two parts 20, 30 arranged one inside the other with a view to them being welded.

The body 11 has a first lateral face 111 and a second lateral face 112, opposite said first lateral face.

The body 11 is produced in a material exhibiting specific characteristics in terms, on the one hand, of mechanical resistance to plastic deformation in order to have a current of very high intensity, of the order of a few hundreds of thousands of amperes, circulate therein, and, on the other hand, of resistance to high temperatures (that is to say a high melting point) so as not to melt during the welding.

In an example of embodiment, the material of the body is made of steel.

The body 11 further comprises a narrow slit 13 extending radially from the tubular aperture 12. Two symmetrically opposite contact plates 14a, 14b extend on either side of the slit 13.

The contact plates 14a, 14b comprise through orifices 15a, 15b for the passage of fixing means (not represented) configured to fix the coil to a base (not represented) linked to the energy storage unit 50 and to the switch or switches 51.

When the switch or switches 51 is/are closed, the contact plates 14a, 14b of the coil 10 are linked to the storage unit 50, and a current of high intensity circulates in the coil 10 producing a magnetic field.

The coil is designed for the current density in a zone of the coil to be sufficient to satisfy the welding conditions. This zone is called active portion 125. It is for example described in the document WO 2012/103873.

In the case of an annular coil as described in this embodiment, the current circulates through one of the contact plates, then into the coil 10 and emerges through the other contact plate. This current is concentrated, in the active portion 125, on a layer delimited by the peripheral surface 121 facing an outer wall of the outer part 20 and of a thickness corresponding to the skin thickness. The current generates, in the tubular aperture 12, a concentrated magnetic field.

In the nonlimiting example of a coil produced in steel, the skin thickness is of the order of a few millimeters for a frequency of a few tens of kHz.

The two parts 20, 30 are advantageously positioned in the tubular aperture such that all or part of the overlap zone 25 is facing the active portion 125.

The overlap zone 25 facing the active portion 125 is called working zone. Said working zone has a predefined length, called working length L. This working length L_{wz} corresponds to a maximum welding length between the inner part and the outer part. In practice, the welding length is substantially less than this working length.

To produce a constant and comparable weld between the two parts, over all the peripheral circumference of said two cylindrical tubular parts 20 and 30, the tubular aperture 12 is preferentially cylindrical, like said two cylindrical tubular parts to be welded.

The outer part 20 has a diameter less than a minimum diameter of the tubular aperture 12.

The peripheral surface 121 has an axial length L_{b} dimensioned so as to be at least equal to the working length L_{wz} of the working zone.

The tubular aperture 12 advantageously has a decreasing cross section over the axial length L_{b} of the peripheral surface 121 of the coil, in a direction starting from the second lateral face 112 toward the first lateral face 111.

In other words, the tubular aperture 12 has a diameter which decreases progressively, in a direction starting from the second lateral face 112 toward the first lateral face 111.

In a preferred embodiment, the tubular aperture 12 has, over the axial length L_{b} of the peripheral surface 121, a succession of three sections, in a direction starting from the second lateral face 112 toward the first lateral face 111:
a first section 122, of length L₁, having a constant cross section,
a second section 123, of length L₂, having a monotonically decreasing cross section,
a third section 124, of length L₃, having a constant cross section.

In other words, the tubular aperture has a diameter d₃, in the third section 124, less than a diameter di, in the first section 122.

The second section is defined by a slope of angle β.

Since the cross section of the tubular aperture 12 in the third section 124 is the smallest cross section, the level of the intensity of the current circulating in the coil will be higher in said third section. Furthermore, the magnetic field lines are closer together and the magnetic pressure is greater. Thus, the portion of the outer part 20 situated in this third section 124 will have a stronger acceleration in the welding method described later.

On the other hand, since the cross section of the tubular aperture 12 in the first section 122 is the largest cross section, the current density circulating in the coil will be lower in the first section, which will reduce the magnetic pressure in said first section. Furthermore, the coil is less stressed mechanically and thermally in this first section.

Such a tubular aperture profile advantageously makes it possible to use a storage unit delivering a lower energy to the coil, which improves the thermal and structural withstand strength of said coil. Such a storage unit delivering a lower energy also offers a financial benefit.

Such a tubular aperture profile also makes it possible to limit the stresses of the coil at the level of the third portion, which makes it possible to increase the life of the coil.

Such a tubular aperture profile also advantageously makes it possible to modify the gap between the coil 10 and the outer part 20, which has an impact on the fundamental parameters that are the collision point speed and the collision angle. Such a profile makes it possible, when the outer part 20 is introduced such that its end is situated at the level of the third section 124, in the smallest cross section, to keep the fundamental parameters within the window of weldability of the pair of materials forming the parts to be welded for a longer time. The quality and effectiveness of the weld between the outer part 20 and the inner part 30 are thus improved.

In a preferred embodiment, the length L₃ of the third section 124 is less than the length L₁ of the first section 122.

In a preferred example of embodiment, the length L₃ is equivalent to 10% of the axial length L_{b} of the peripheral surface 121, the length L₁ is equivalent to 30% of the axial length L_{b} of the peripheral surface 121 and the slope of the second section 123 has an angle β of 15°.

A reduced length L₃ and a slope of pronounced angle β transfers the stresses to the third section 124 of the tubular aperture 12.

In another preferred embodiment, when a pusher is used, the length L₃ of the third section 124 is equivalent to the length L₁ of the first section 122.

In a preferred example of such an embodiment, for a coil produced in steel, the length L₃ and the length L₁ are equivalent to 20% of the axial length L_{b} of the peripheral surface 121 and the slope of the second section 123 has an angle β of 10°.

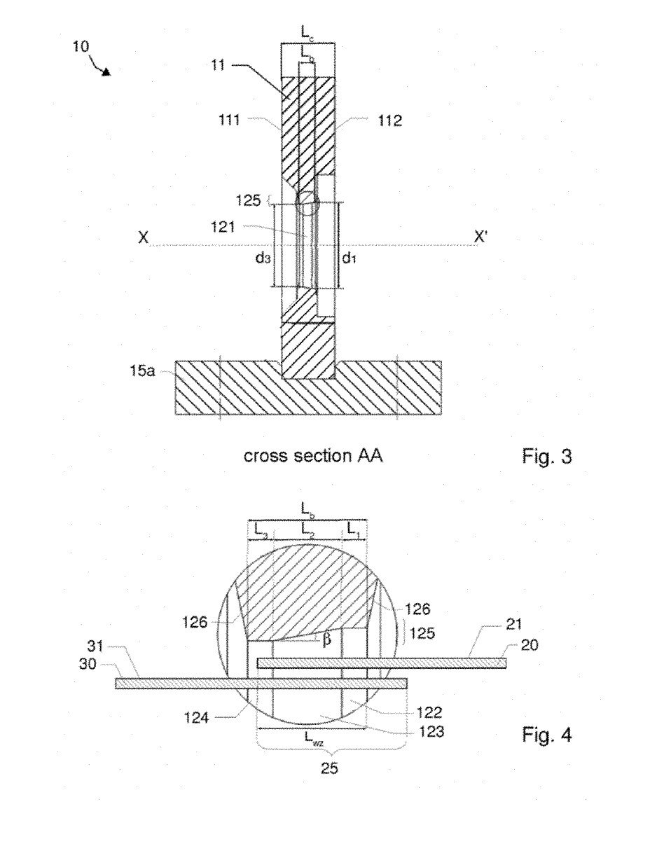

In an embodiment illustrated in FIGS. 1 and 3, to withstand the current circulating in the coil and strengthen said coil, said body has a length L_{c}, between the first 111 and the second 112 lateral faces, greater than the axial length L_{b} of the peripheral surface 121.

In another embodiment, to further significantly reduce the plastic deformations of the coil during the welding, and consequently improve the mechanical hold, the active portion 125 comprises, on either side of said peripheral surface of the tubular aperture, a chamfered portion 126.

In another embodiment, to eliminate the effects of spiking and/or of pinching of the magnetic field lines, the tubular aperture 12 comprises, on either side of the peripheral surface 121, a rounded peripheral edge. Thus, the current density is better distributed, which avoids a concentration of stresses and also a temperature spike.

An example of a welding method using such a coil is now described.

To weld two parts together by magnetic-pulse welding, the method comprises a first step of positioning in the coil the two cylindrical tubular parts to be welded.

The two cylindrical tubular parts are positioned one inside the other to form the overlap zone.

The two cylindrical tubular parts are arranged in the coil 10 such that the working zone is placed in the tubular aperture of the coil, facing the active portion 125.

The two cylindrical tubular parts are held, in the tubular aperture, coaxially to one another, in an axial direction XX′ and with the tubular aperture of the coil, elongate in said axial direction XX′, by fixing means (not represented in the figures).

In a preferred example of implementation, the outer part 20 is positioned such that its end is placed in the smallest cross section of the tubular aperture 12, that is to say at the level of the third section 124.

The method then comprises a step of magnetic-pulse welding.

The working zone is subjected to a magnetic field originating from the active portion of the coil such that a pressure is exerted on the outer wall of the outer part, or on an outer wall of the pusher when said pusher is necessary, and presses it closely against an outer wall of the inner part to provoke the permanent bonding thereof.

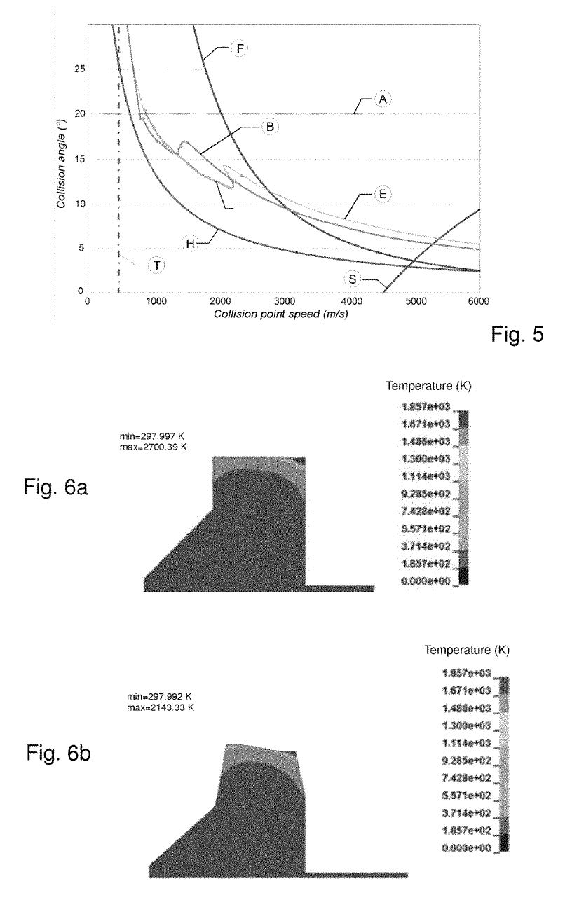

FIG. 5 illustrates the welding distances obtained by a coil of the prior art and a coil according to an embodiment of the invention, for a same given pair of materials.

The coil of the prior art and the coil according to an embodiment of the invention exhibit the following identical characteristics:
a tubular aperture of 50 mm diameter,
the peripheral surface 121 has an axial length L_{b} of 8 mm,
the material is made of steel,
the distance between the two parts to be welded is 2 mm,
the frequency is a few tens of kiloHz.

The working length L_{WZ} is identical to the axial length L_{b} of the peripheral surface, in other words 7 mm.

The tubular aperture of the coil of the prior art has a constant cross section.

The tubular aperture of the coil according to an embodiment of the invention has:
a first section, of length L₁ equal to 20% of the axial length L_{b} of the peripheral surface of the coil, of 80 mm diameter;
a third section, of length L₃ equal to 20% of the axial length L_{b} of the peripheral surface of the coil, of 80 mm diameter;
a second section, having a slope angle β of 10°.

For a given pair of materials for the tubular parts, whatever the form of the tubular aperture of the coil, the welding window is determined. This welding window is defined by the subsonic (curve S), hydrodynamic (curve H), fusion (curve F) and transition (curve T) curves. A collision angle limit, at 20°, is also indicated (curve A) in FIG. 5. More comprehensive explanations concerning the welding window can be found in the documents entitled “Explosive welding of aluminum to aluminum: analysis, computations and experiments”, Grignon et al., International Journal of Impact Engineering 30 (2004) p. 1333-1351.

In this welding window, the curve E represents the trend of the pair (collision angle, collision point speed) for a coil of the prior art. The bold portion E_{g} of the curve E indicates the distance welded (almost five triangles representing 5 mm of welding). Over this welded distance, the collision angle varies enormously, between 15 and 20°, with possible repercussions on the quality of the weld.

The curve B represents the trend of the pair (collision angle, collision point speed) for a coil according to the chosen embodiment of the invention. Such a coil makes it possible to weld a zone over a distance of 6 mm (6 circles). Furthermore, it can be seen that, over most of this distance, the collision angle is kept almost constant, around 16°.

FIGS. 6a and 6b illustrates the results of simulation of the behavior in terms of temperature of a coil of the invention according to a first embodiment compared to a coil of the prior art.

The coil of the prior art has the following characteristics:
a tubular aperture, of constant cross section over the axial length of the peripheral surface, of 50 mm diameter,
the peripheral surface 121 has an axial length L_{b} of 8 mm,
the material is made of steel,
the distance between the two parts to be welded is a few millimeters,
the frequency is a few tens of kHz.

The working length L_{WZ} is identical to the axial length L_{b} of the active portion, in other words 8 mm.

The tubular parts are produced in a metal material, such as, for example, aluminum, copper or steel.

The coil of the invention according to a first embodiment has the following characteristics:

the peripheral surface 121 has an axial length L_{b} of 8 mm,
a tubular aperture having:
   a first section, of length L₁ equal to 30% of the axial length L_{b} of the peripheral surface of the coil, of 50 mm diameter;
   a third section, of length L₃ equal to 10% of the axial length L_{b} of the peripheral surface of the coil, of 50 mm diameter;
   a second section, having a slope angle β of 15°.
the material of the coil is made of steel,
the distance between the two parts to be welded is a few millimeters,
the frequency is a few tens of kHz.

The tubular aperture of the coil is chamfered on either side of the peripheral surface.

The materials of the parts to be welded are made of metal, such as, for example, aluminum, copper or steel, which are identical or different.

FIG. 6a represents a transverse view of a radial cross section of the coil of the prior art. FIG. 6a illustrates the result of the simulation of the behavior in terms of temperature of the coil of the prior art.

FIG. 6b represents a transverse view of a radial cross section of the coil according to the first embodiment. FIG. 6b illustrates the result of the simulation of the behavior in terms of the temperature of the coil according to the first embodiment.

It can be seen that the maximum temperature generated in the coil of the prior art is 2700 K, whereas the maximum temperature generated in the coil of the invention according to the first embodiment is 2143 K, which represents a temperature differential of the order of 550 K.

It can also be seen that the temperature of the coil of the prior art is concentrated significantly on an edge of the peripheral surface of the coil, whereas the temperature of the coil of the invention according to the first embodiment is distributed over the two edges of the peripheral surface of the coil.

The above description clearly illustrates that, through its various characteristics and the advantages thereof, the present invention achieves the objectives that it set out to achieve. In particular, it provides a magnetic-pulse welding coil and an associative magnetic-pulse welding method that are suited to the welding of parts made of materials with low thermal conductivity. It advantageously exhibits a profile at the level of the peripheral surface 121 of the aperture such that the thermal and mechanical stresses applied to the coil during the welding are significantly reduced, improving the life of the coil. Such a form of coil also offers improved welding between the parts.

1-6. (canceled)

7. A coil to magnetic-pulse weld tubular parts comprising an active portion of which a peripheral surface is positionable to face a working zone of a mutual overlap zone of the tubular parts, the peripheral surface defines a zone in a form of a tubular aperture elongated in an axial direction and having a predetermined axial length, the tubular aperture has, in the axial direction, over the predetermined axial length of the peripheral surface, two sections of constant cross section linked together by a section of monotonically increasing cross section.

8. The coil as claimed in claim 7, wherein the active portion comprises, on either side of the peripheral surface defining the tubular aperture, at least one of a chamfered and shelved portion.

9. The coil as claimed in claim 7, further comprising a magnetic field concentrator comprising the active portion.

10. A welding set comprising the coil as claimed in claim 7 and two tubular parts.

11. The welding set as claimed in claim 10, wherein the two tubular parts are arranged one inside other coaxially, in a position at a level of the coil.

12. The welding set as claimed in claim 10, wherein the two tubular parts are positioned in the tubular aperture such that all or part of the mutual overlap zone is facing the active portion.

13. A method for magnetic-pulse welding of two tubular parts, comprising the steps of:
arranging the two tubular parts relative to one another to form a working zone, facing a peripheral surface of a coil such that an end of one of the tubular parts is positioned at a level of a smallest cross section of a tubular aperture, the peripheral surface defines a zone in a form of a tubular aperture elongated in an axial direction and having a predetermined axial length, wherein the tubular aperture has, in the axial direction, over the predetermined axial length of the peripheral surface, two sections of constant cross section linked together by a section of monotonically increasing cross section; and
subjecting the working zone to a magnetic field such that a pressure is exerted on a wall of one of the tubular parts to press against a wall of other tubular part to provoke a permanent bonding thereof.

14. The magnetic-pulse welding method as claimed in claim 13, further comprising a step of arranging the two tubular parts into an inner and outer parts such that an end of the outer part is positioned at the level of the smallest cross section of the tubular aperture.
